(19) United States
(12) Patent Application Publication
(10) Pub. No.: US 2022/0284491 A1
(43) Pub. Date: Sep. 8, 2022

(54) DETERMINING ACCURACY OF VALUES OF AN ATTRIBUTE OF AN ITEM FROM A DISTRIBUTION OF VALUES OF THE ATTRIBUTE ACROSS ITEMS WITH COMMON ATTRIBUTES

(71) Applicant: Maplebear, Inc.(dba Instacart), San Francisco, CA (US)

(72) Inventor: Chao Qu, Toronto (CA)

(21) Appl. No.: 17/191,134

(22) Filed: Mar. 3, 2021

(51) Int. Cl. G06Q 30/06; G06F 16/953; G06Q 10/08; G06Q 30/02

(52) U.S. Cl. CPC G06Q 30/0603; G06F 16/953; G06Q 30/0623; G06Q 10/087; G06Q 30/0206

(57) ABSTRACT

An online concierge system maintains an item catalog maintaining a hierarchical taxonomy of the items. Using the hierarchical taxonomy, the online concierge system selects a cohort of items. For the cohort, the online concierge system selects an attribute and generates a distribution of values of the attribute across items in the cohort. From the distribution, the online concierge system identifies one or more items having values for the attributes that are outliers. The online concierge system may provide the identified one or more items to users for manual review to identify possible errors in the item catalog. The data regarding whether manual review identified errors is saved by the online converge system for later use as labels to train a machine learning model for detecting errors.

### BACKGROUND

This disclosure relates generally to maintaining a catalog of values for various items, and more specifically to evaluating accuracy of values of an attribute of an item based on a distribution of values of the attribute across items having one or more common characteristics.

In current online concierge systems, an interface is presented to a customer identifying items offered by a physical warehouse. The customer may identify different items via the interface and provide selections of items for an order to the online concierge system. In current online concierge systems, the shoppers may be sent to various warehouses with instructions to fulfill orders for items, and the shoppers then find the items included in the customer order in a warehouse.

When generating the interface to a consumer from which the consumer selects one or more items, the online concierge system receives information identifying items offered by a warehouse from the warehouse and generates the interface from the information received from the warehouse. The online concierge system may categorize the items identified by the warehouse from the received information and use the categorization when generating the interface. For example, the online concierge system leverages information from the warehouse describing items offered by the warehouse so the items are categorized to replicate their placement in aisles within the warehouse.

Additionally, the online concierge system displays values for different attributes of items from the warehouse to the user. Example attributes include a brand of an item, a price of an item, a quantity of an item, and one or more keywords describing the item. Conventional online concierge systems present values for attributes received from the warehouse, which may present inaccurate or inconsistent information to consumers. For example, a warehouse provides a price for a set of multiple copies of an item along with information describing attributes of a single copy of an item. As an example, a warehouse provider provides an image of a single bottle of a beverage along with a price for a case of the beverage, causing the online concierge system to display inconsistent information about the beverage. Discrepancies between different attributes of an item displayed to a user by the online concierge system may discourage users from ordering items through the online concierge system.

### SUMMARY

The online concierge system receives an item catalog that contains a plurality of items offered for purchase from a warehouse via an online system. Each entry in the product catalog includes information identifying an item (e.g., an item identifier, an item name) and one or more attributes of the item. Example attributes of an item include: one or more keywords, a brand offering the item, a manufacturer of the item, a type of the item, a price of the item, a quantity of the item, a size of the item and any other suitable information. Additionally, one or more attributes of an item may be specified by the online concierge system for the item. Example attributes specified by the online concierge system for an item include: a category for the item, one or more sub-categories for the item, and any other suitable information for the item. In some embodiments, the online concierge system includes a trained machine learning classification model that is applied to attributes and values of attributes of an item to generate a probability of an item being in a category or level of the hierarchical taxonomy. The online concierge system includes an item in a category for which the trained machine learning classification model determines the item as a maximum probability of including the item from the attributes and the values of the attributes of the item.

The online concierge system obtains a hierarchical taxonomy of items offered by the warehouse from the item catalog received from the warehouse, with different levels in the hierarchical taxonomy providing different levels of specificity about items included in the levels. The differing levels of specificity may identify to any suitable attribute or combination of attributes of the items. For example, the hierarchical taxonomy includes multiple levels, with each level corresponding to different levels of specificity of items included in the product catalog. In various embodiments, higher levels in the hierarchical taxonomy include less detail about items, so greater numbers of items that tend to be more diverse are included in higher levels. Similarly, lower levels in the hierarchical taxonomy include greater detail about items, so fewer numbers of items that tend to have higher similarity are included in the lower levels. (For example, a lower level in the hierarchy may contain only different brands of mustard, whereas a higher level may contain other condiments like ketchup or relish.) The online concierge system may have different levels within the hierarchical taxonomy correspond to different categories for items, so application of the trained machined learned classification model by the online system allocates items to levels within the hierarchical taxonomy in some embodiments.

From the item catalog, the online concierge system selects a cohort of items. In some embodiments, this selection leverages the hierarchical taxonomy of the items to create the cohort. Each item of the cohort includes one or more common attributes. For example, the online concierge system selects items having a particular attribute or having a specific combination of attributes as the cohort of items. In various embodiments, the particular attribute or combination of attributes used to select the cohort of items identifies a specific level in the hierarchical taxonomy of the product catalog. In another example, the online concierge system selects items having a specific category and having one or more specific keywords.

The online concierge system selects a specific attribute for the cohort. The specific attribute is an attribute expected to have a similar value across items of the cohort. For example, the specific attribute is an attribute predicted to have a range of values within a threshold distance of a specific value, such as a mean, median, or mode of prior values. The specific attribute is expected to have a normal distribution across items having one or more common attributes in various embodiments. In various embodiments, the online concierge system retrieves previous values for an attribute and determines an average value for the attribute and a percentage of previous values within a threshold standard deviation of the average value. In response to at least a threshold percentage of the previous values being within the threshold standard deviation of the average value, the online concierge system selects the specific attribute. However, the online concierge system may use any suitable information to select the specific attribute in various embodiments.

From the item catalog, the online concierge system retrieves a value of the specific attribute for each item in the cohort. In various embodiments, the online concierge system generates a normalized value of the specific attribute for each item in the cohort from the retrieved values. For example, the specific attribute is price, and the online concierge system generates a normalized price for an item of the cohort as a ratio of the price of the item to a weight of the item or a volume of the item. As another example, the specific attribute is price and the online concierge system generates a normalized price for an item of the cohort as a ratio of the price of the item to a value of a quantity of the item. However, in other embodiments, the online concierge system generates a normalized value of the specific attribute for an item of the cohort using any suitable characteristic of an item, so the normalized value is relative to a specific quantity for each item of the cohort.

The online concierge system generates a normal range of values for the specific attribute from the retrieved values of the specific attributes for items of the cohort and identifies one or more items having values of the specific attribute outside of the normal range. For example, the online concierge system generates a distribution of values of the specific attribute from the retrieved values and identifies one or more items having values for the specific attribute from the distribution. In various embodiments, the online concierge system determines a standard deviation of the distribution and identifies one or more items with values for the specific attribute that are at least a threshold number of standard deviations from a mean of the retrieved values for the specific attribute. Alternatively, the online concierge system determines an interquartile range of the distribution and identifies the one or more items from the interquartile range. For example, the online concierge system determines the interquartile range of the distribution and generates an amount by multiplying the interquartile range by a constant. In the preceding example, the online concierge system identifies items having values of the specific attribute greater than a sum of a value of the third quartile for the distribution and the amount; the online concierge system also identifies items having values of the specific attribute less than a difference of a value of the first quartile for the distribution and the amount. However, the online concierge system may use any suitable technique for identifying items with values for the specific attribute that are outliers relative to values of other items of the cohort for the specific attribute.

The online concierge system transmits information describing an identified item to a process for validating the value of the specific attribute for the identified items. For example, information describing identified items associated with the indication are transmitted to one or more users, such as administrator users, for review. Review by the one or more users determine whether one or more values of an identified item are erroneous. Based on the review of an identified item by one or more users, the online concierge system modifies values of one or more attributes of the identified items determined to be erroneous. For example, review of an identified item determines that a location of the identified item in the hierarchical taxonomy is erroneous. In some embodiments, a user reviewing the value of the specific attribute of the identified item modifies a value of an attribute of an identified item. For example, the online concierge system changes a category associated with the identified item in response to instructions from the user reviewing the identified item, so the identified item is associated with a category including other items having values for the specific attribute closer to the value of the specific attribute of the identified item.

In some embodiments, the online concierge system stores information indicating whether an identified item had one or more values determined to be erroneous. For example, the online concierge system applies a label to an identified item determined to have an erroneous value for an attribute, where the label indicates whether a value of an attribute was erroneous (e.g., 1 if the value was correct and 0 if the value was erroneous) . The labeled identified item, along with attributes and values of the attributes for the labeled identified item may be provided to train an error detection machine learning model used by the online concierge system to generate a likelihood of a value for the specific attribute of an item is erroneous generate values for one or more attributes of items, allowing the error detection machine learning model to be refined. For example, information describing identified items labeled as including an erroneous value are provided to a user of the online concierge system, such as an administrator. The user subsequently reviews information describing an identified item and modify a value of one or more attributes accordingly. For example, the user adjusts a value of the specific attribute based on information from the warehouse. As another example, the user adjusts a value of another attribute, such as a value of a category associated with the identified item. The error detection machine learning model may be any machine learning model, such as a neural network, boosted tree, gradient boosted tree or random forest model trained using any suitable technique or techniques.

### BRIEF DESCRIPTION OF THE DRAWINGS

FIG. 1 illustrates an environment of an online shopping concierge service, according to one embodiment.

FIG. 2 is a diagram of an online shopping concierge system, according to one embodiment.

FIG. 3A is a diagram of a customer mobile application (CMA), according to one embodiment.

FIG. 3B is a diagram of a shopper mobile application (SMA), according to one embodiment.

FIG. 4 is a flowchart of a process for predicting inventory availability, according to one embodiment.

FIG. 5 is a flowchart of a process for updating training datasets for an error detection machine-learning model, according to one embodiment.

FIG. 6 is a flowchart of a method for identifying accuracy of values for attributes in an item catalog maintained by an online concierge system based on values of an attribute for items having one or more common characteristics, according to one embodiment.

FIG. 7 is an example distribution of values of a specific attribute of items in a cohort of items having one or more common attributes, according to one embodiment.

The figures depict embodiments of the present disclosure for purposes of illustration only. One skilled in the art will readily recognize from the following description that alternative embodiments of the structures and methods illustrated herein may be employed without departing from the principles, or benefits touted, of the disclosure described herein.

### DETAILED DESCRIPTION

### System Overview

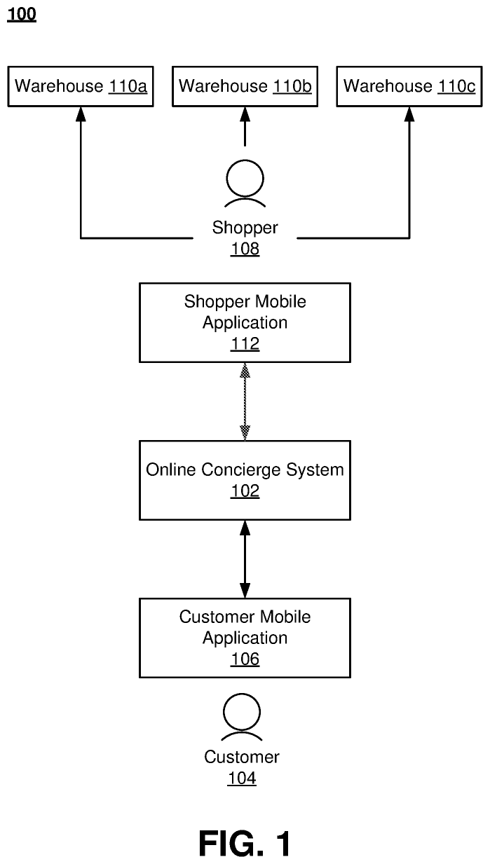

FIG. 1 illustrates an environment 100 of an online platform, according to one embodiment. The figures use like reference numerals to identify like elements. A letter after a reference numeral, such as “110a,” indicates that the text refers specifically to the element having that particular reference numeral. A reference numeral in the text without a following letter, such as “110,” refers to any or all of the elements in the figures bearing that reference numeral. For example, “110” in the text refers to reference numerals “110a” and/or “110b” in the figures.

The environment 100 includes an online concierge system 102. The system 102 is configured to receive orders from one or more customers 104 (only one is shown for the sake of simplicity). An order specifies a list of goods (items or products) to be delivered to the customer 104. The order also specifies the location to which the goods are to be delivered, and a time window during which the goods should be delivered. In some embodiments, the order specifies one or more retailers from which the selected items should be purchased. The customer may use a customer mobile application (CMA) 106 to place the order; the CMA 106 is configured to communicate with the online concierge system 102.

The online concierge system 102 is configured to transmit orders received from customers 104 to one or more shoppers 108. A shopper 108 may be a contractor, employee, or other person (or entity) who is enabled to fulfill orders received by the online concierge system 102. The shopper 108 travels between a warehouse and a delivery location (e.g., the customer's home or office). A shopper 108 may travel by car, truck, bicycle, scooter, foot, or other mode of transportation. In some embodiments, the delivery may be partially or fully automated, e.g., using a self-driving car. The environment 100 also includes three warehouses 110a, 110b, and 110c (only three are shown for the sake of simplicity; the environment could include hundreds of warehouses). The warehouses 110 may be physical retailers, such as grocery stores, discount stores, department stores, etc., or non-public warehouses storing items that can be collected and delivered to customers. Each shopper 108 fulfills an order received from the online concierge system 102 at one or more warehouses 110, delivers the order to the customer 104, or performs both fulfillment and delivery. In one embodiment, shoppers 108 make use of a shopper mobile application 112 which is configured to interact with the online concierge system 102.

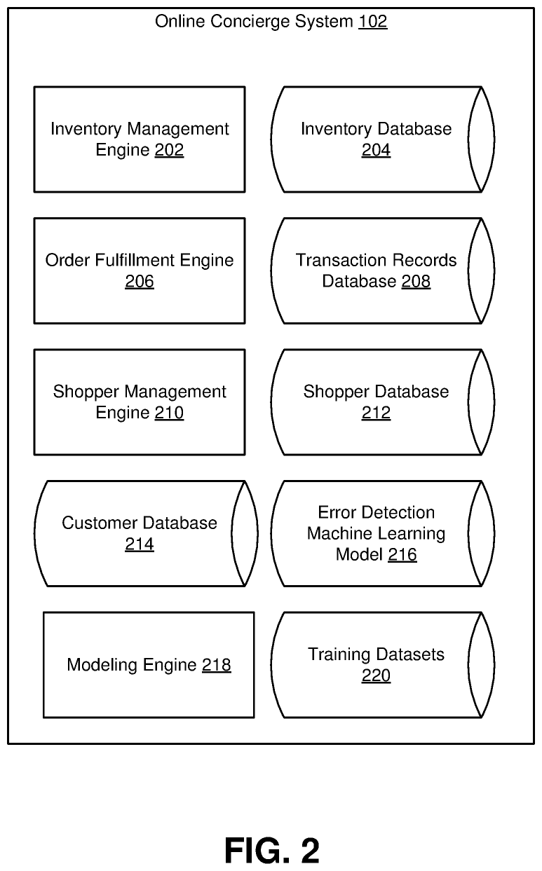

FIG. 2 is a diagram of an online concierge system 102, according to one embodiment. The online concierge system 102 includes an inventory management engine 202, which interacts with inventory systems associated with each warehouse 110. In one embodiment, the inventory management engine 202 requests and receives inventory information maintained by the warehouse 110. The inventory of each warehouse 110 is unique and may change over time. The inventory management engine 202 monitors changes in inventory for each participating warehouse 110. The inventory management engine 202 is also configured to store inventory records in an inventory database 204. The inventory database 204 may store information in separate records—one for each participating warehouse 110—or may consolidate or combine inventory information into a unified record. Inventory information includes both qualitative and qualitative information about items, including size, color, weight, SKU, serial number, and so on. In one embodiment, the inventory database 204 also stores purchasing rules associated with each item, if they exist. For example, age-restricted items such as alcohol and tobacco are flagged accordingly in the inventory database 204. Additional inventory information useful for predicting the availability of items may also be stored in the inventory database 204. For example, for each item-warehouse combination (a particular item at a particular warehouse), the inventory database 204 may store a time that the item was last found, a time that the item was last not found (a shopper looked for the item but could not find it), the rate at which the item is found, and the popularity of the item.

Inventory information provided by the inventory management engine 202 may supplement the training datasets 220. Inventory information provided by the inventory management engine 202 may not necessarily include information about the outcome of picking a delivery order associated with the item, whereas the data within the training datasets 220 is structured to include an outcome of picking a delivery order (e.g., if the item in an order was picked or not picked).

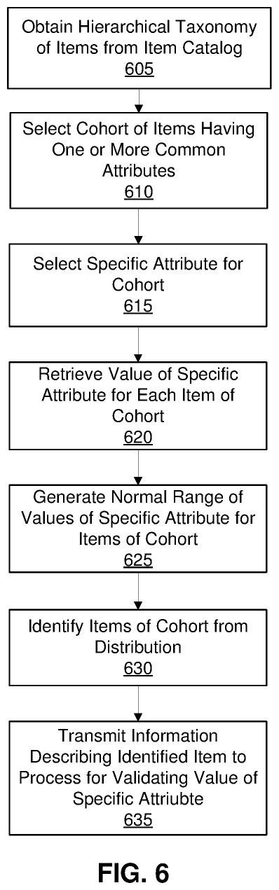

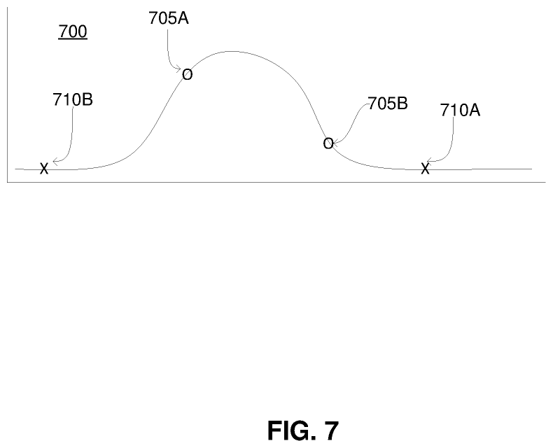

In various embodiments, the inventory management engine 202 evaluates accuracy of one or more attributes of items from an item catalog obtained from a warehouse 110. As further described below in conjunction with FIGS. 6 and 7, the inventory management engine 202 identifies a cohort of items from the item catalog, where each item of the cohort has one or more common attributes. The inventory management engine 202 selects a specific attribute of items of the cohort and generates a distribution of values of the attribute from information about the items obtained from the warehouse 110. In various embodiments, the specific attribute is an attribute predicted to have a range of values within a threshold distance of a specific value, such as a mean, median, or mode of prior values. For example, the specific attribute is expected to have a normal distribution across items having one or more common attributes in various embodiments. Based on locations of values of the specific attribute within the distribution, the inventory management engine 202 identifies one or more items of the cohort. For example, the inventory management engine 202 identifies an item of the cohort having a value of the specific attribute that is greater than a threshold distance from a particular quartile (e.g., first quartile, third quartile) of the distribution. As further described below in conjunction with FIG. 6, the inventory management engine 202 may provide information describing an identified item (e.g., an identifier of the item, attributes of the item, values of attributes of the item) to a user for manual review, allowing a user to modify values of one or more attributes of the item. Alternatively, the inventory management engine 202 applies a trained machine learning model to values of attributes of an identified item to determine a likelihood of one or more of the values being inaccurate.

The online concierge system 102 also includes an order fulfillment engine 206, which is configured to synthesize and display an ordering interface to each customer 104 (for example, via the customer mobile application 106). The order fulfillment engine 206 is also configured to access the inventory database 204 in order to determine which products are available at which warehouse 110. The order fulfillment engine 206 may supplement the product availability information from the inventory database 204 with an item availability predicted by the item availability model 216. The order fulfillment engine 206 determines a sale price for each item ordered by a customer 104. Prices set by the order fulfillment engine 206 may or may not be identical to in-store prices determined by retailers (which is the price that customers 104 and shoppers 108 would pay at the retail warehouses). The order fulfillment engine 206 also facilitates transactions associated with each order. In one embodiment, the order fulfillment engine 206 charges a payment instrument associated with a customer 104 when he/she places an order. The order fulfillment engine 206 may transmit payment information to an external payment gateway or payment processor. The order fulfillment engine 206 stores payment and transactional information associated with each order in a transaction records database 208.

In some embodiments, the order fulfillment engine 206 also shares order details with warehouses 110. For example, after successful fulfillment of an order, the order fulfillment engine 206 may transmit a summary of the order to the appropriate warehouses 110. The summary may indicate the items purchased, the total value of the items, and in some cases, an identity of the shopper 108 and customer 104 associated with the transaction. In one embodiment, the order fulfillment engine 206 pushes transaction and/or order details asynchronously to retailer systems. This may be accomplished via use of webhooks, which enable programmatic or system-driven transmission of information between web applications. In another embodiment, retailer systems may be configured to periodically poll the order fulfillment engine 206, which provides detail of all orders which have been processed since the last request.

The order fulfillment engine 206 may interact with a shopper management engine 210, which manages communication with and utilization of shoppers 108. In one embodiment, the shopper management engine 210 receives a new order from the order fulfillment engine 206.

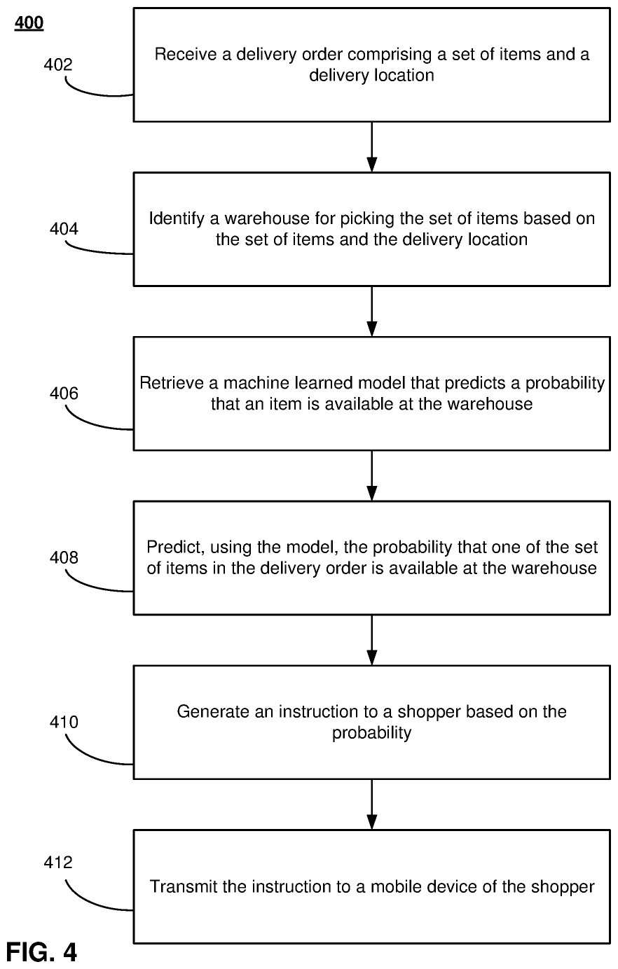

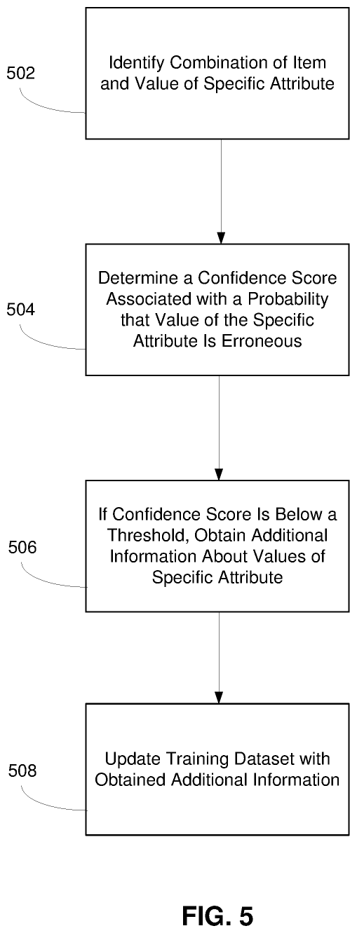

The shopper management engine 210 identifies the appropriate warehouse to fulfill the order based on one or more parameters, such as a probability of item availability determined by an item availability model 216, the contents of the order, the inventory of the warehouses, and the proximity to the delivery location. The shopper management engine 210 then identifies one or more appropriate shoppers 108 to fulfill the order based on one or more parameters, such as the shoppers' proximity to the appropriate warehouse 110 (and/or to the customer 104), his/her familiarity level with that particular warehouse 110, and so on. Additionally, the shopper management engine 210 accesses a shopper database 212 which stores information describing each shopper 108, such as his/her name, gender, rating, previous shopping history, and so on. Methods that can be used to identify a warehouse 110 at which a shopper 108 can likely find most or all items in an order are described with respect to FIGS. 4 and 5.

As part of fulfilling an order, the order fulfillment engine 206 and/or shopper management engine 210 may access a customer database 214 which stores information describing each customer. This information could include each customer's name, address, gender, shopping preferences, favorite items, stored payment instruments, and so on.

In various embodiments, the online concierge system 102 includes an item availability model that determines a probability an item is available at a warehouse. The item availability model may be used to predict item availability for items being displayed to or selected by a customer or included in received delivery orders. A single item availability model is used to predict the availability of any number of items. The item availability model can be configured to receive as inputs information about an item, the warehouse for picking the item, and the time for picking the item. The item availability model may be adapted to receive any information that the modeling engine identifies as indicators of item availability. At minimum, the item availability model receives information about an item-warehouse pair, such as an item in a delivery order and a warehouse at which the order could be fulfilled

### Machine Learning Model

The online concierge system 102 further includes an error detection machine learning model 216, a modeling engine 218, and training datasets 220. The modeling engine 218 uses the training datasets 220 to generate the error detection machine learning model 216. The error detection machine learning model 216 can learn from the training datasets 220, rather than follow only explicitly programmed instructions. The inventory management engine 202, can use the error detection machine learning model 216 to determine a probability that a value of an attribute of an item is erroneous. The error detection machine learning model 216 may be used to determine a likelihood of an item having an erroneous value for an attribute in response to a value of a specific attribute of the item being outside of a normal range of values determined for items having one or more common attributes with the item The online concierge system 102 maintains multiple error detection machine learning models 216, each corresponding to a different attribute of an items, in some embodiments. Alternatively, a single error detection machine learning model 216 is used to predict whether any number of attributes of items have an erroneous value

The error detection machine learning model 216 can be configured to receive as inputs information providing information about values for a specific attribute corresponding to the error detection machine learning module 216. For example, the error detection machine learning model 216 receives a category of an item, a value of the specific attribute, and information describing a distribution of values of the specific attribute across other items having one or more common attributes with the item. The error detection machine learning model 216 may also receive information identifying deviations between the value of the specific attribute for the item and values of the specific attribute for other items having a particular attribute (e.g., brand, manufacturer) in common with the item. The error detection machine learning model 216 may be adapted to receive any information that the modeling engine 218 identifies as indicators of item availability. Items stored in the inventory database 204 may be identified by item identifiers. As described above, various attributes and corresponding values for the attributes may be stored for each item in the inventory database 204.

The error detection machine learning model 216 contains a set of functions generated by the modeling engine 218 from the training datasets 220 that relate the item, value of the specific attribute of the item, or any other relevant inputs, to a probability that the value of the specific attribute of the item is erroneous. Thus, for an item and a value of a specific attribute of the item, the error detection machine learning model 216 outputs a probability that the value of the specific attribute the item is erroneous. The error detection machine learning model 216 constructs the relationship between the item, the value of the specific attribute, or any other inputs and the probability of the value of the specific attribute being erroneous that is generic enough to apply to any number of combinations of values of the specific attribute and items. In some embodiments, the probability output by the error detection machine learning model 216 includes a confidence score. The confidence score may be the error or uncertainty score of the probability of the value of the specific attribute being erroneous and may be calculated using any standard statistical error measurement. In some examples, the confidence score is based in part on whether the combination of the value of the specific attribute and the item was accurate for previous items having one or more particular common attributes with the item (e.g., if the value of the specific attribute item was previously determined to be accurate for an item having a particular common attribute with the item). In some examples, the confidence score is based in part on the age of the data for the item. The set of functions of the error detection machine learning model 216 may be updated and adapted following retraining with new training datasets 220. The error detection machine learning model 216 may be any machine learning model, such as a neural network, boosted tree, gradient boosted tree or random forest model. In some examples, the error detection machine learning model 216 is generated from XGBoost algorithm.

Based on the probability of value of the specific attribute of the item generated by the error detection machine learning model 216 being erroneous, the online concierge system 102 may transmit information describing the item to a process for validating the value of the specific attribute of the item. In various embodiments, in response to the probability of the value of the specific attribute of the item equaling or exceeding a threshold probability, the online concierge system 102 transmits information describing the item to a user, such as an administrator user of the online concierge system 102. The user reviews the value of the specific attribute to determine whether to modify values of one or more attributes of the item. The user may modify the value of the specific attribute and save the modified value in association with the item. Alternatively, the user modifies a value of an alternative attribute of the item, such as modifying a value of a category associated with the item

The training datasets 220 relate a variety of different factors to known determinations of whether a value of a specific attribute of an item was erroneous based on the prior results of the process reviewing the value of the specific attribute for items. The training datasets 220 include the items previously identified included in previous delivery orders, whether the value of the specific attribute for a previously identified item was erroneous, a variety of attributes associated with each of the items, and information describing values of the specific attribute (e.g., a distribution of values of the specific attribute across items having one or more common attributes, etc.). Each piece of data in the training datasets 220 includes the outcome of a previous determination of whether a value of the specific attribute of an item was erroneous. The attributes of the items and information describing values of the specific attribute may be determined by the error detection machine learned model 216 to be statistically significant factors predictive of the validity of a value of the specific attribute for an item. For different specific attributes, the item attributes and information describing values of the specific attribute across items having one or more common characteristics that are predictors of validity of the value of the specific item may be different. For each specific attribute, the error detection machine learning model 216 may weight these factors differently, where the weights are a result of a “learning” or training process on the training datasets 220. The training datasets 220 are very large datasets taken across a wide cross section of warehouses, items, attributes, and corresponding values of the attributes. The training datasets 220 are large enough to provide a mapping from an item and a value for a specific attribute of the item to a probability that the value for the specific attribute is erroneous. In addition to previous delivery orders, the training datasets 220 may be supplemented by information provided by the inventory management engine 202. In some examples, the training datasets 220 are historic determinations of whether values for a specific attribute are erroneous for different items from manual review of the values for the specific attribute by users of the online concierge system 102

### Customer Mobile Application

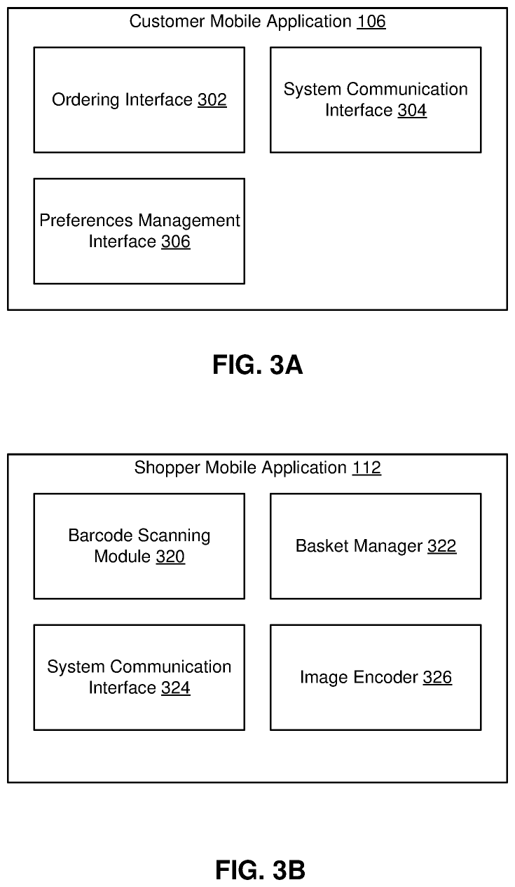

FIG. 3A is a diagram of the customer mobile application (CMA) 106, according to one embodiment. The CMA 106 includes an ordering interface 302, which provides an interactive interface with which the customer 104 can browse through and select products and place an order. The CMA 106 also includes a system communication interface 304 which, among other functions, receives inventory information from the online shopping concierge system 102 and transmits order information to the system 102. The CMA 106 also includes a preferences management interface 306 which allows the customer 104 to manage basic information associated with his/her account, such as his/her home address and payment instruments. The preferences management interface 306 may also allow the customer to manage other details such as his/her favorite or preferred warehouses 110, preferred delivery times, special instructions for delivery, and so on.

### Shopper Mobile Application

FIG. 3B is a diagram of the shopper mobile application (SMA) 112, according to one embodiment. The SMA 112 includes a barcode scanning module 320 which allows a shopper 108 to scan an item at a warehouse 110 (such as a can of soup on the shelf at a grocery store). The barcode scanning module 320 may also include an interface which allows the shopper 108 to manually enter information describing an item (such as its serial number, SKU, quantity and/or weight) if a barcode is not available to be scanned. SMA 112 also includes a basket manager 322 which maintains a running record of items collected by the shopper 108 for purchase at a warehouse 110. This running record of items is commonly known as a “basket”. In one embodiment, the barcode scanning module 320 transmits information describing each item (such as its cost, quantity, weight, etc.) to the basket manager 322, which updates its basket accordingly. The SMA 112 also includes a system communication interface 324 which interacts with the online shopping concierge system 102. For example, the system communication interface 324 receives an order from the system 102 and transmits the contents of a basket of items to the system 102. The SMA 112 also includes an image encoder 326 which encodes the contents of a basket into an image. For example, the image encoder 326 may encode a basket of goods (with an identification of each item) into a QR code which can then be scanned by an employee of the warehouse 110 at check-out.

### Training a Model to Identify Errors in an Item Attribute

FIG. 5 is a flowchart illustrating a method for updating training datasets for an error detection machine learning model, according to one embodiment. The training datasets may be the training datasets 220 as shown in FIG. 2. While the training datasets 220 include large datasets of information collected from previous determinations of whether values of a specific attribute of items were erroneous, certain specific attributes or certain items may have less information associated with them in the training datasets 220 than other specific attributes or items. For example, if a specific attribute is new or is an attribute of a limited number of items, it may be more difficult to build an accurate probability of whether a value of the specific attribute is erroneous in the error detection machine learning model 216. One way to improve the ability of the error detection machine learning model 216 to accurately predict probabilities of values of specific attributes being erroneous is to increase the information about the specific attribute in the training datasets 220 and add new information. With larger and/or more recent datasets on the specific attribute or items having the specific attribute, the modeling engine 218 can build more statistically meaningful connections between the machine-learning factors described with reference to FIG. 2 and the probability of a value of the specific attribute being erroneous.

The online concierge system 102 may improve the error detection machine learning model 216 by increasing the datasets for particular specific attributes in the training datasets 220 with low confidence scores. The online concierge system 102 (e.g., the inventory management engine 202 using the error detection machine learning model 216) identifies 502 a combination of a value of a specific attribute and an item. For example, the combination of specific attribute and item is identified 502 from specific attributes for which a probability of a value of the specific attribute being erroneous predicted by the error detection machine learning model 216 was incorrect (e.g., the value had at least a threshold probability of being erroneous but was determined by manual to be accurate). For values of specific attributes for which the probability of the value of the specific attributes was incorrect, the online concierge system 102 may determine if the specific attributes have sufficient associated information within the training datasets 220. If the online concierge system 102 determines that the incorrect probability was a result of insufficient or stale information in the training datasets 220, it may identify combinations of the value of the specific attribute and items to update the training datasets 220.

Additionally or alternatively, a combination of a value of a specific attribute and an item is identified 502 from new items offered by the online concierge system 102 or for new specific attributes of items identified to the online concierge system 102. For example, the online concierge system 102 identifies a specific attribute identified by a warehouse 110 that has not previously been provided to the online concierge system 102 by a warehouse 110. The lack of previous information about values for a newly provided specific attribute may lead to a low confidence score for determined probabilities of values of the specific attribute being erroneous

The online concierge system 102 (e.g., the inventory management engine 202 using the error detection machine learning model 216) inputs the item, a value of specific attribute, and characteristics of the item and of the specific attribute (as further described above in conjunction with FIG. 2) into the error detection machine learning model 216 and determines 504 a confidence score associated with a probability that a value of the specific attribute is erroneous. The online concierge system 102 may determine 504 probabilities and/or confidence scores for values of the specific attribute for all or for some items having one or more particular common characteristics. The confidence score is generated along with the probability of a value of the specific attribute being erroneous by the error detection machine learned model 216. The confidence score may be an error associated with the probability of the value of the specific attribute being erroneous. The confidence score indicates specific attributes that may not have enough training data in the training datasets 220 to generate a statistically significant connection between the probability of the value of the specific attribute being erroneous and information about the specific attribute or attributes of items. In some alternate embodiments, the online concierge system 102 may identify, using the error detection machine learning model 216, combinations of items and values of specific attributes with a low confidence score, e.g., all values of a specific attribute for which a probability of the value being erroneous has a confidence score below a particular threshold. This list of combinations of items and values of a specific attribute may be filtered, e.g., based on item popularity, warehouse 110, or one or more other factors.

In response to the determined confidence level of a combination of a value of a specific attribute and an item below a threshold, the online concierge system 102 obtains 506 additional information about the specific attribute for which a probability of a value of the specific attribute being erroneous has a confidence score below a threshold. A confidence score threshold may be specified between 0 and 1. A threshold confidence score may be 0.3, such that in response to a confidence score below 0.3, the online concierge system 102 obtains 506 additional information about a specific attribute by requesting additional information from one or more warehouses 110 offering the item of the combination of item and value of the specific attribute or from a brand or manufacturer of the item of the combination of item and value of the specific attribute. In some embodiments, the online concierge system 102 also considers the probability of the value of the specific attribute being erroneous for the combination of the item and the value of the specific attribute. For example, if a combination of an item and the value of the specific attribute has a confidence level slightly below the threshold, but a very low or very probability of the value of the specific attribute being erroneous, the online concierge system 102 may determine not to collect new information about the combination of value of the specific attribute and item. In some embodiments, the threshold used for the confidence score may depend on the probability of the value of the specific attribute being erroneous, or vice versa.

Additional information obtained 506 about values for the specific attribute or about the item are used to update 508 the training datasets 220. In some embodiments, the online concierge system 102 obtains 506 information about a normal range of values for the specific attribute from a warehouse 110 or from a manufacturer of the item and may obtain 506 information about values of the specific attribute for multiple items having a particular common attribute. The online concierge system 102 updates 508 the training dataset 220 with new information about the specific attribute, including ranges of values for the specific attribute, and any other information about the specific attribute or characteristics of items having the specific attribute, as described with respect to FIG. 2. In response to the new information obtained 506 by the online concierge system 102, the modeling engine 218 may update or retrain the error detection machine learning model 216 with the updated training datasets 220.

### Identifying Errors in Classification of Items in an Item Catalog

FIG. 6 is a flowchart of one embodiment of a method for identifying accuracy of values for attributes in an item catalog maintained by an online concierge system 102 based on values of an attribute for items having one or more common characteristics. In various embodiments, the method includes different or additional steps than those described in conjunction with FIG. 6. Further, in some embodiments, the steps of the method may be performed in different orders than the order described in conjunction with FIG. 6. The method described in conjunction with FIG. 6 may be carried out by the online concierge system 102 in various embodiments.

The online concierge system 102 receives an item catalog received from a warehouse 110, where each entry in the product catalog includes information identifying an item (e.g., an item identifier, an item name) and one or more attributes of the item. Example attributes of an item include: one or more keywords, a brand offering the item, a manufacturer of the item, a type of the item, a price of the item, a quantity of the item, a size of the item and any other suitable information. Additionally, one or more attributes of an item may be specified by the online concierge system 102 for the item. Example attributes specified by the online concierge system 102 for an item include: a category for the item, one or more sub-categories for the item, and any other suitable information for the item. In some embodiments, the online concierge system 102 includes a trained machine learning classification model that is applied to attributes and values of attributes of an item to generate a probability of an item being in a category or level of the hierarchical taxonomy. The online concierge system 102 includes an item in a category for which the trained machine learning classification model determines the item as a maximum probability of including the item from the attributes and the values of the attributes of the item.

The online concierge system 102 obtains 605 a hierarchical taxonomy of items offered by the warehouse 110 from the item catalog received from the warehouse 110, with different levels in the hierarchical taxonomy providing different levels of specificity about items included in the levels. The differing level of specificity may identify to any suitable attribute or combination of attributes of the items. For example, different levels of the hierarchical taxonomy specify different combinations of attributes for items, so items in lower levels of the hierarchical taxonomy have a greater number of attributes, while items in higher levels of the hierarchical taxonomy have a fewer number of attributes. For example, the hierarchical taxonomy includes multiple levels, with each level corresponding to different levels of specificity of items included in the product catalog. In various embodiments, higher levels in the hierarchical taxonomy include less detail about items, so greater numbers of items are included in higher levels. Similarly, lower levels in the hierarchical taxonomy include greater detail about items, so fewer numbers of items are included in the lower levels. Hence, a level in the hierarchical taxonomy identifies items with less specificity than another level in the hierarchical taxonomy that is below the level, while the level identifies items with greater specificity than an additional level that is higher in the hierarchical taxonomy than the level. The online concierge system 102 may have different levels within the hierarchical taxonomy correspond to different categories for items, so application of the trained machined learned classification model by the online system 102 allocates items to levels within the hierarchical taxonomy in some embodiments.

From the hierarchical taxonomy of the item catalog, the online concierge system 102 selects 610 a cohort of items. Each item of the cohort includes one or more common attributes. For example, the online concierge system 102 selects 610 items having a particular attribute or having a specific combination of attributes as the cohort of items. In various embodiments, the particular attribute or combination of attributes used to select 610 the cohort of items identifies a specific level in the hierarchical taxonomy of the product catalog. For example, the online concierge system 102 selects 610 items having a specific category and having one or more specific keywords. The online concierge system 102 may receive input from a user, such as an administrator, identifying one or more attributes specifying the cohort and selects 610 the cohort as items having the identified one or more attributes.

The online concierge system 102 selects 615 a specific attribute for the cohort. The specific attribute is an attribute expected to have a similar value across items of the cohort. For example, the specific attribute is an attribute predicted to have a range of values within a threshold distance of a specific value, such as a mean, median, or mode of prior values. The specific attribute is expected to have a normal distribution across items having one or more common attributes in various embodiments. In various embodiments, the online concierge system 102 retrieves previous values for an attribute and determines an average value for the attribute and a percentage of previous values within a threshold standard deviation of the average value. In response to at least a threshold percentage of the previous values being within the threshold standard deviation of the average value, the online concierge system 102 selects 615 the specific attribute. However, the online concierge system 102 may use any suitable information to select 615 the specific attribute in various embodiments. Further, in some embodiments, the online concierge system 102 receives an input from a user or other source identifying the specific attribute to select 615 the specific attribute.

From the item catalog, the online concierge system 102 retrieves 620 a value of the specific attribute for each item in the cohort. In various embodiments, the online concierge system 102 generates a normalized value of the specific attribute for each item in the cohort from the retrieved values. For example, the specific attribute is price, and the online concierge system 102 generates a normalized price for an item of the cohort as a ratio of the price of the item to a weight of the item or a volume of the item. As another example, the specific attribute is price and the online concierge system 102 generates a normalized price for an item of the cohort as a ratio of the price to a quantity included in the item. However, in other embodiments, the online concierge system 102 generates a normalized value of the specific attribute for an item of the cohort using any suitable characteristic of an item, so the normalized value is relative to a specific quantity for each item of the cohort.

The online concierge system 102 generates 625 a normal range of values for the specific attribute from the retrieved values of the specific attributes for items of the cohort and identifies 630 one or more items having values of the specific attribute outside of the normal range. For example, the online concierge system generates a distribution of values of the specific attribute from the retrieved values and identifies 630 one or more items having values for the specific attribute from the distribution. In various embodiments, the online concierge system 102 determines a standard deviation of the distribution and identifies 630 one or more items with values for the specific attribute that are at least a threshold number of standard deviations from a mean of the retrieved values for the specific attribute. Alternatively, the online concierge system 102 determines an interquartile range of the distribution and identifies 630 the one or more items from the interquartile range. For example, the online concierge system 102 determines the interquartile range of the distribution and generates an amount by multiplying the interquartile range by a constant. In the preceding example, the online concierge system 102 identifies 630 items having values of the specific attribute greater than a sum of a value of the third quartile for the distribution and the amount; the online concierge system 102 also identifies 630 items having values of the specific attribute less than a difference of a value of the first quartile for the distribution and the amount. However, the online concierge system 102 may use any suitable technique for identifying 630 items with values for the specific attribute that are outliers relative to values of other items of the cohort for the specific attribute.

The online concierge system 102 transmits 635 information describing an identified item to a process for validating the value of the specific attribute for the identified items. For example, information describing identified items associated with the indication is transmitted 635 to one or more users, such as administrator users, for review. Review by the one or more users determine whether one or more values of an identified item are erroneous. Based on the review of an identified item by one or more users, the online concierge system 102 modifies values of one or more attributes of the identified items determined to be erroneous. For example, review of an identified item determines that a location of the identified item in the hierarchical taxonomy is erroneous. In some embodiments, a user reviewing the value of the specific attribute of the identified item modifies a value of an attribute of an identified item. For example, the online concierge system 102 changes a category associated with the identified item in response to instructions from the user reviewing the identified item, so the identified item is associated with a category including other items having values for the specific attribute closer to the value of the specific attribute of the identified item. As another example, the online concierge system 102 removes the identified item from the product catalog in response to receiving an instruction from a user of the online concierge system 102 reviewing the identified item.

In some embodiments, the online concierge system 102 stores information indicating whether an identified item had one or more values determined to be erroneous. For example, the online concierge system 102 applies a label to an identified item determined to have an erroneous value for an attribute, where the label indicates whether a value of an attribute was erroneous (e.g., 1 if the value was correct and 0 if the value was erroneous). The labeled identified item, along with attributes and values of the attributes for the labeled identified item may be provided to train an error detection machine learning model used by the online concierge system 102 to generate a likelihood of a value for the specific attribute of an item is erroneous generate values for one or more attributes of items, allowing the error detection machine learning model to be refined, as further described above in conjunction with FIGS. 2 and 5. For example, information describing identified items labeled as including an erroneous value are provided to a user of the online concierge system, such as an administrator. The user subsequently reviews information describing an identified item and modify a value of one or more attributes accordingly. For example, the user adjusts a value of the specific attribute based on information from the warehouse. As another example, the user adjusts a value of another attribute, such as a value of a category associated with the identified item. The error detection machine learning model may be any machine learning model, such as a neural network, boosted tree, gradient boosted tree or random forest model trained using any suitable technique or techniques.

FIG. 7 is an example distribution 700 of values of a specific attribute of items in a cohort. As further described above in conjunction with FIG. 6, each item in the cohort has one or more common attributes. The distribution 700 identifies values of the specific attribute for each item of the cohort. For purposes of illustration, FIG. 7 identifies items 705A, 705B and items 710A, 710B on the distribution 700. The locations of items 705A, 705B on the distribution 700 correspond to values of the specific attribute for items 705A, 705B. Similarly, locations of items 710A, 710B on the distribution 700 correspond to values of the specific attribute for items 710A, 710B. In the example shown by FIG. 7, the online concierge system 102 identifies items 710A, 710B because of the positions of the values of the specific attribute for items 710A, 710B on the distribution 700. For example, the values of the specific attribute for items 710A, 710B are greater than a threshold number of standard deviations from a mean value of the specific attribute for the distribution 700. However, as further described above in conjunction with FIG. 6, the online concierge system 102 may use any suitable criteria to identify items 710A, 710B from the distribution based on values of the specific attribute for items 710A, 710B relative to values of the specific attribute across the distribution 700. This allows the online concierge system 102 to identify potential errors or discrepancies in a large number of items by comparing values of a specific attribute for different items to a distribution of values of the specific attribute for various items having one or more common characteristics. Hence, the online concierge system 102 uses values of the specific attribute to identify potential discrepancies of the specific attribute from existing values of the specific attribute for various items.

### Additional Considerations

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium, which include any type of tangible media suitable for storing electronic instructions and coupled to a computer system bus. Furthermore, any computing systems referred to in the specification may include a single processor or may be architectures employing multiple processor designs for increased computing capability.

Embodiments of the invention may also relate to a computer data signal embodied in a carrier wave, where the computer data signal includes any embodiment of a computer program product or other data combination described herein. The computer data signal is a product that is presented in a tangible medium or carrier wave and modulated or otherwise encoded in the carrier wave, which is tangible, and transmitted according to any suitable transmission method.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method comprising:
obtaining an item catalog from a warehouse at an online concierge system, the item catalog identifying items and attributes of items, along with values for the attributes of the items;
selecting a cohort of items from the item catalog, each item of the cohort having one or more common attributes;
selecting a specific attribute of items of the cohort;
generating a normal range of values of the specific attribute for items of the cohort from the item catalog;
identifying an item of the cohort having a specific value of the specific attribute outside the normal range; and
transmitting information describing the identified item to a method for validating the specific value of the specific attribute.

2. The method of claim 1, wherein generating the normal range of values of the specific attribute for items of the cohort from the hierarchical taxonomy of items comprises:
generating a distribution of values of the specific attribute for items of the cohort; and
determining the normal rage of values as values of the specific attribute within a set number of standard deviations of a mean of the distribution.

3. The method of claim 2, wherein identifying the item of the cohort having the specific value of the specific attribute outside the normal range comprises:
determining a standard deviation of the distribution; and
identifying an item of the cohort with a value for the specific attribute that is at least a threshold number of standard deviations from the mean of the distribution of values for the specific attribute.

4. The method of claim 2, wherein identifying the item of the cohort having the specific value of the specific attribute outside the normal range comprises:
determining an interquartile range of the distribution; and
identifying the item of the cohort from the interquartile range.

5. The method of claim 4, wherein identifying the item of the cohort from the interquartile range comprises:
generating an amount by multiplying the interquartile range by a constant;
identifying the item in response to the item having a value of the specific attribute greater than a sum of a value of a third quartile for the distribution and the amount

6. The method of claim 4, wherein identifying the item of the cohort from the interquartile range comprises:
generating an amount by multiplying the interquartile range by a constant; and
identifying the item in response to the item having a value of the specific attribute less than a difference of a value of a first quartile for the distribution and the amount.

7. The method of claim 1, wherein the specific attribute comprises an attribute predicted to have a range of values within a threshold distance of a specific value.

8. The method of claim 7, wherein the specific value comprises a mean of prior values for the attribute.

9. The method of claim 7, wherein selecting the specific attribute of items of the cohort comprises:
retrieving values the online concierge system previously received for an attribute;
determining an average value of the attribute from the values the online concierge system previously received for the attribute;
determining a percentage of the values the online concierge system previously received for the attribute within a threshold number of standard deviations of the average value; and
selecting the attribute as the specific attribute in response to the percentage of the values the online concierge system previously received for the attribute within the threshold number of standard deviations of the average value equaling or exceeding a threshold percentage.

10. The method of claim 1, wherein generating the normal range of values of the specific attribute for items of the cohort from the item catalog comprises:
generating a normalized value of the specific attribute for each item in the cohort from values of the specific attribute from the hierarchical taxonomy of items; and
generating a range of normalized values of the specific attribute for items of the cohort.

11. The method of claim 10, wherein the specific attribute is price and the normalized value of the price comprises a ratio of a price of an item of a cohort to a value of a quantity of the item of the cohort.

12. A computer program product comprising a non-transitory computer readable storage medium having instructions encoded thereon that, when executed by a processor, cause the processor to:
obtain an item catalog from a warehouse at an online concierge system, the item catalog identifying items and attributes of items, along with values for the attributes of the items;
select a cohort of items from the item catalog, each item of the cohort having one or more common attributes;
select a specific attribute of items of the cohort;
generate a normal range of values of the specific attribute for items of the cohort from the item catalog;
identify an item of the cohort having a specific value of the specific attribute outside the normal range; and
transmit information describing the identified item to a method for validating the specific value of the specific attribute.

13. The computer program product of claim 12, wherein generate the normal range of values of the specific attribute for items of the cohort from the hierarchical taxonomy of items comprises:
generate a distribution of values of the specific attribute for items of the cohort; and
determine the normal rage of values as values of the specific attribute within a set number of standard deviations of a mean of the distribution.

14. The computer program product of claim 13, wherein identify the item of the cohort having the specific value of the specific attribute outside the normal range comprises:
determine a standard deviation of the distribution; and
identify an item of the cohort with a value for the specific attribute that is at least a threshold number of standard deviations from the mean of the distribution of values for the specific attribute.

15. The computer program product of claim 13, wherein identify the item of the cohort having the specific value of the specific attribute outside the normal range comprises:
determine an interquartile range of the distribution; and
identify the item of the cohort from the interquartile range.

16. The computer program product of claim 15, wherein identifying the item of the cohort from the interquartile range comprises:
generate an amount by multiplying the interquartile range by a constant;
identify the item in response to the item having a value of the specific attribute greater than a sum of a value of a third quartile for the distribution and the amount

17. The computer program product of claim 15, wherein identify the item of the cohort from the interquartile range comprises:
generate an amount by multiplying the interquartile range by a constant; and
identify the item in response to the item having a value of the specific attribute less than a difference of a value of a first quartile for the distribution and the amount.

18. The computer program product of claim 12, wherein the specific attribute comprises an attribute predicted to have a range of values within a threshold distance of a specific value.

19. The computer program product of claim 18, wherein the specific value comprises a mean of prior values for the attribute.

20. The computer program product of claim 18, wherein select the specific attribute of items of the cohort comprises:
retrieve values the online concierge system previously received for an attribute;
determine an average value of the attribute from the values the online concierge system previously received for the attribute;
determine a percentage of the values the online concierge system previously received for the attribute within a threshold number of standard deviations of the average value; and
select the attribute as the specific attribute in response to the percentage of the values the online concierge system previously received for the attribute within the threshold number of standard deviations of the average value equaling or exceeding a threshold percentage.

21. The computer program product of claim 12, wherein generate the normal range of values of the specific attribute for items of the cohort from the item catalog comprises:
generate a normalized value of the specific attribute for each item in the cohort from values of the specific attribute from the hierarchical taxonomy of items; and
generate a range of normalized values of the specific attribute for items of the cohort.

22. The computer program product of claim 21, wherein the specific attribute is price and the normalized value of the price comprises a ratio of a price of an item of a cohort to a value of a quantity of the item of the cohort.
